(19) United States
(12) Patent Application Publication
(10) Pub. No.: US 2007/0140749 A1
(43) Pub. Date: Jun. 21, 2007

(54) DEVELOPING DEVICE FOR DEVELOPING A LATENT IMAGE USING A TWO-COMPONENT DEVELOPER

(76) Inventors: Satoru Miyamoto, Ebina-shi (JP); Makoto Yasuda, Hiratsuka-shi (JP); Tomio Kondou, Numadu-shi (JP); Shinichiro Yagi, Numadu-shi (JP); Kousuke Suzuki, Numadu-shi (JP); Hitoshi Iwatsuki, Numadu-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/608,521

(22) Filed: Dec. 8, 2006

(30) Foreign Application Priority Data
Dec. 8, 2005 (JP) 2005-355000

(51) Int. Cl. G03G 15/09

(52) U.S. Cl. 399/267

(57) ABSTRACT

An improved developing device for developing latent images to toner images is provided for stabilizing the amount of the developer on the developing bearing member, in which the amount of toner particles consumed in one second for the development process “a” (mg/sec) and circumferential velocity of the surface of the developer bearing member “b” (m/sec) are arranged to satisfy the following relationships (1) and (2) at the condition in which the amount of the developer after 20 hours of rotation of the developer bearing member exceeds the amount of the developer before rotation:
45 mg/m<a/b (1)
a/b<110 mg/m (2).

### BACKGROUND OF THE INVENTION

1. Field of the Invention

The present invention relates to a developing device for developing a latent image, particularly using a two-component developer which includes toner particles and carrier particles.

2. Discussion of the Background

In a conventional developing device for use in developing a latent image to give a toner image with a two-component developer, the developing process typically includes the following steps:

(1) The two component developer including toner particles and magnetic carrier particles is borne on a developer bearing member. The developer bearing member typically includes a cylindrically formed rotating sleeve and fixed magnets inside the sleeve.

(2) As the sleeve rotates, the developer is carried to a developing area in which the developer bearing member faces to a latent image bearing member, such as a photoconductive drum.

(3) In the developing area, the developer on the developer bearing member raises along the magnetic field caused by the magnets in the sleeve and forms a chain-like shape commonly referred to as a “magnetic brush”. The magnetic brush touches the latent image bearing member.

(4) Toner particles are transferred from the magnetic brush to the latent image bearing member by application of a DC bias or a DC bias superimposed with an AC bias, and thus forms the toner image.

This type of developing device (hereinafter, it is described as a “two component developing device” for simplicity) can be used both in a monochrome image forming apparatus and a color image forming apparatus. In the monochrome image forming apparatus, the latent image is developed with toner particles having one color. In the color image forming apparatus, the latent image is developed with a plurality of toner particles of different colors. As an example of the color image forming apparatus, in a “full color image apparatus”, the latent image is developed by three kinds of toner particles having yellow, magenta and cyan colors, or by four kinds of toner particles having yellow, magenta, cyan and black colors.

Recently, the need for an image forming apparatus to have a longer life span than ever is increasing, in addition to the need for high image quality and high reproducability. To fulfill the needs for high image quality and high reproducability, it is preferable that the size of toner particles becomes small, and it is also considered to make the size of the carrier particles small.

The two-component developing device typically has a regulating member configured to regulate an amount of the developer on the developer bearing member. If an excessive amount of the developer is carried to the developing area and the length of the magnetic brush becomes too long, the surface of the latent image bearing member may be scratched. A scratched surface of the latent image bearing member may cause disorder of the image quality, for example, as follows:

(1) a disorder known as “local omission of the trailing edge of an image”. The “local omission of the trailing edge of an image” is a phenomenon in which toner particles are not developed on the rear edge of the latent image when an image with uniform density area is developed (including a uniform density area expressed by halftone).

(2) poor reproduction for a thin line image.

In order to avoid these disorders and to fulfill the latest requirements for high image quality, it is effective to make the distance between the regulating member and the developer bearing member small so that the amount of the developer on the developer bearing member is small. (Hereinafter, the words “the amount of the developer” used in the expressions such as “the amount of the developer on the developer bearing member” or “the amount of the developer borne on the developer bearing member” means the amount of the developer on the developer bearing member at the developing area in which the developer bearing member faces to the latent image bearing member, magnetic brush is formed and the development process proceeds.)

However, if the amount of the developer is too small, the ability to develop the latent image may decrease. So a method, such as one of the following, may be required to acquire enough image density.

(1) rotating the sleeve faster than the latent image bearing member

(2) setting the developing potential high (the developing potential is a difference of the voltage between the developer bearing member and the latent image bearing member)

(3) increasing the amount of toner particles in the two component developer and decreasing the amount of electric charge of the toner particles

But these methods are not enough to fully solve the problems. For example, if the sleeve rotates faster than the latent image bearing member, the carrier particles tend to transfer to the latent image bearing member while the magnetic brush scrapes the latent image bearing member. And if the developing potential is increased, carrier particles having relatively weak magnetism tend to transfer to the latent image bearing member or the life span of the photoconductive drum tends to become short because of the increased electric current passing through it.

Also, the smaller the distance between the regulating member and the developer bearing member is, the more stress will be imposed on carrier particles when carrier particles pass between the regulating member and the developer bearing member. Excessive stress on carrier particles may scrape off the coating film of each carrier particle. Scraping off the coating film of carrier particles will decrease fluidity of the developer and decrease the amount of the developer borne on the developer bearing member. If the amount of the developer on the developer bearing member is decreased, the ability to develop the latent image may decrease as mentioned above. Also, it is known that scraping off the coating film of carrier particles tends to increase the amount of carrier particles transferred to the latent image bearing member.

Although there are various types of developer bearing member, the ability to bear the developer generally tends to decline because of physical wear of the developer bearing member or because of adhesion of toner particles to the developer bearing member. So it is difficult to prevent a decline of the ability to bear the developer on the developer bearing member for a long time.

It is especially difficult to prevent the decline of the ability to bear the developer when toner particles containing wax are used. Toner particles containing wax have been used recently especially in color image forming apparatuses because these toner particles make it possible to use a fixing device without a mechanism for providing oil to the fixing device. However, because the melting point of such toner particles is relatively low, these toner particles tend to adhere to the surface of the developer bearing member and tend to make the ability of the developer bearing member to bear the developer decline.

Therefore, it is required to stabilize the amount of the developer borne on the developer bearing member and maintain the quality of toner images, especially when a color toner image is formed. Japanese Laid-Open Patent Publication No. 2002-62725 discloses a developer bearing member whose average peak-to-peak spacing of the convexities and concavities are set to a particular value. However, the proposed developer bearing member still has difficulty in preventing physical wear.

Japanese Laid-Open Patent Publication No. 2002-258616 discloses a developer bearing member in which the arrangement of magnets inside the sleeve is improved. However, it is still difficult to prevent the decline of the amount of the developer caused by the decline of the fluidity of the developer because the deterioration of carrier particles is not taken into consideration by the reference.

Japanese Laid-Open Patent Publication No. 2002-214837 discloses toner particles whose weight average particle diameter, average circularity of form, THF insoluble matter of the binder resin component and distribution of molecular weight is set to particular values. However, the toner particles are not sufficient to prevent the decline of the ability to bear the developer on the developer bearing member and improve the quality of toner images.

Therefore, the above-mentioned references have not provided a sufficient solution to stabilize the amount of the developer on the developer bearing member in terms of the quality of toner images.

### SUMMARY OF THE INVENTION

Accordingly, one object of the present invention is to provide a developing device in which the amount of the developer on the developer bearing member is stabilized, preferably regardless of the environment or condition of use, so that the quality of toner images are stabilized.

This object of the present invention, and others which will become apparent when the following detailed description is taken into consideration, individually or in combination, have been satisfied by the discovery of a developing device having a developer bearing member configured to bear a two-component developer including magnetic carrier particles and toner particles and configured to carry the developer to the developing area in which the developer forms a magnetic brush so that toner particles can transfer from the developer bearing member to the latent image bearing member. The amount of toner particles consumed in one second for the development process “a” (mg/sec) and circumferential velocity of the surface of the developer bearing member “b” (m/sec) satisfy the following relationships (1) and relationship (2) at the condition in which the amount of the developer after 20 hours of rotation of the developer bearing member exceeds the amount of the developer before rotation:
45 mg/in<a/b (1)
a/b<10 mg/m (2)

### BRIEF DESCRIPTION OF THE DRAWINGS

These and other objects, features and advantages of the present invention will become apparent upon consideration of the following description of the preferred embodiments of the present invention taken in conjunction with the accompanying drawings, wherein:

FIG. 1 is a diagram illustrating an example of the image forming apparatus of the present invention.

FIG. 2 is a diagram illustrating an example of the write device used in the image forming apparatus.

FIG. 3 is a diagram illustrating an example of the photoconductive unit used in the image forming apparatus.

FIG. 4 is a diagram illustrating an example of the developing device used in the image forming apparatus.

### DETAILED DESCRIPTION OF THE PREFERRED EMBODIMENTS

An exemplary embodiment of the present invention is explained in detail below with reference to the accompanying drawings. The exemplary embodiment is a preferred embodiment and the present invention is not restricted to the details of this embodiment.

According to the present invention, the ability to stabilize the amount of the developer on the developer bearing member is improved in the developing device which satisfies the following relationships (1) and (2).
45 mg/m<a/b (1)
a/b<110 mg/m (2)

In relationships (1) and (2), “a” (mg/sec) indicates the amount of toner particles consumed in one second for the development process and “b” (rn/sec) indicates the circumferential velocity of the surface of the developer bearing member, where “a” and “b” are measured at a condition in which a first amount of the developer defined below starts becoming greater than a second amount of the developer defined below.

The first amount of the developer: an amount of developer on the developer bearing member measured after the developer bearing member rotates for 20 hours.

The second amount of the developer: an amount of developer on the developer bearing member measured before the developer bearing member rotates.

By stabilizing the amount of the developer on the developer bearing member, the quality of the toner images are also stabilized and scattering of toner particles may be suppressed if present.

It is preferable to add aluminum oxide particles on the core particle of carrier particles and to arrange the weight average diameter of carrier particles from 20 μm to 60 μm for improving the resolution and quality of toner images.

It is also preferable to arrange the volume resistivity value of carrier particles from 10[Log (Ωcm)] to 16 [Log (Ωcm)] for suppressing the adhesion of carrier particles to the latent image bearing member. Additionally, the reproduction of thin line images can be improved by arranging the amount of the developer on the developer bearing member at the developing area to be from 30 mg/cm2 to 60 mg/cm2.

There are two reasons for the decline of the amount of the developer on the developer bearing member. The first reason is the decline of the fluidity of the developer. The surface of the carrier particle tends to become rough because of the stress imposed on carrier particles. For example, if a carrier particle includes a core material covered by a binder coat, the surface of the carrier particle tends to be rough because the binder coat is scraped off. The roughness on the surface of carrier particles leads to decline of the fluidity of the developer.

The second reason is, as mentioned above, the decline of the ability to bear and carry the developer caused by the physical wear of the developer bearing member.

The present inventors have found that it is difficult to suppress the physical wear of the developer bearing member. A new approach was devised by the present inventors to stabilize the amount of the developer on the developer bearing member. The idea is to compensate the physical wear of the developer bearing member by enriching the fluidity of the developer. As mentioned above, the decline of the fluidity of carrier particles is caused by roughness on the surface of carrier particles. It has now been found to be possible to improve the decline of the fluidity of the developer or, under some conditions, to even raise the fluidity of the developer by providing additive agents of toner particles to the concavities on the surface of carrier particles.

The proper amount of additive agents provided depends on the value “a/b”. Here, “a” (mg/sec) indicates the amount of toner particles consumed in one second for the development process and “b” (m/sec) indicates the circumferential velocity of the surface of the developer bearing member

If the value “a/b” is small, or the amount of toner particles consumed is small during a certain amount of rotation of the developer bearing member, the fluidity of the developer declines because the roughness on the surface of the developer is not sufficiently compensated by the provided additive agents. It leads to the decline of the amount of the developer on the developer bearing member.

On the other hand, if the value “a/b” is large, or the amount of toner particles consumed is large during a certain amount of rotation of the developer bearing member, the fluidity of the developer raises because the roughness on the surface of the developer is sufficiently compensated by the provided additive agents. It leads to the increase in the amount of the developer on the developer bearing member.

The image area proportion in an image to be printed can have a wide variety. And the number of sheets printed at one printing job also can vary widely. But as a matter of fact, the majority of users print out images with low image area proportion and print out a relatively small number of sheets at one printing job. In consideration of this fact, it is possible to provide a developing device in which the amount of the developer on the developer bearing member is stabilized for the majority of users, by arranging the value of “a/b” to be greater than 45 mg/m at the condition in which the amount of the developer after 20 hours of rotation of the developer bearing member exceeds the amount of the developer before rotation. By stabilizing the amount of the developer on the developer bearing member, the quality of toner images is also stabilized and the developer can be used for a longer time.

On the other hand, if the value of “a/b” exceeds 110 mg/m, the amount of the developer declines gradually and disorders such as shattering of toner particles or drop of toner particles may happen.

If additive agents are added to carrier particles to arrange the feature of carrier particles such as resistivity or chargeability, it is preferable to add aluminum oxide particles as additive agents in terms of the effective provision of additive agents to the concavities on the surface of carrier particles. The effective provision of additive agents maintains the fluidity of the developer.

It is also preferable to arrange the amount of the developer on the developer bearing member to be 30 mg/cm to 60 mg/cm² for transferring toner particles from the developer bearing member to the latent image bearing member.

If the amount of the developer on the developer bearing member is smaller than 30 mg/cm², the electric bias between the developer bearing member and the latent image bearing member should be increased for development process. But the increase of the electric bias is not preferable in terms of the adhesion of carrier particles to the latent image bearing member.

And if the amount of the developer on the developer bearing member is larger than 60 mg/cm², the drop of the developer from the developer bearing member tends to happen at the downstream of the rotation of the developer bearing member. Also, the density of the developer tends to increase and the fluidity of the developer tends to decline at the area in which the developer bearing member faces to the latent image bearing member. The decline of the fluidity of the developer makes it difficult to provide toner particles smoothly to the latent image bearing member and a disorder of toner images tends to happen such as insufficient density, unevenness of the density, “local omission of the trailing edge of an image” and partial lack of toner images. So it is preferable to set the amount of the developer to be small in terms of a good reproduction of a thin line image.

It is also preferable to use carrier particles whose weight average diameter is from 20 μm to 45 μm.

[1] Because the surface area per volume is large, such carrier particles can give enough frictional charging to an individual toner particle. So the number of toner particles having little or reverse charging quantity can be decreased.

[2] Due to the large surface area per volume and low background fouling, the average charging quantity of toner particles can be set small and an image having a good density can be provided. So small diameter carrier particles can reduce the difficulty of dealing with small diameter toner particles and can make the most of small diameter toner particles.

[3] Because carrier particles have a small diameter, a magnetic brush with high density can be formed and because of the good fluidity of the tip of the brush, toner images have little traces from the tip of the brush.

However, conventional small diameter carrier particles have a drawback that carrier particle adhesion to the latent image bearing member surface tends to happen because the magnetic moment of small diameter carrier particles tends to be small and the magnetic force to keep carrier particles on the developer bearing member tends to decline. The adhered carrier particles may injure the latent image bearing member surface or fixing device.

Carrier adhesion to the latent image bearing member can be improved by using carrier particles whose volume resistivity value is not less than 10[Log (Ωcm)] and not greater than 16 [Log (Ωcm)]. When the volume resistivity value is greater than 16[Log (Ωcm)], the edge effect may become an unacceptable level.

Here, [Log (Ωcm)] represents a logarithm. Particles having volume resistivity value n[Log (Ωcm)] are the particles having a volume resistivity value n-th power of 10[Ωcm].

The volume resistivity value of carrier particles is a converted value from a value measured by a high-resistance measure instrument after carrier particles are placed between resistance measurement parallel electrodes having a gap of 2 mm and applying 1000 V DC bias for 30 sec.

It should be noted that when the volume resistivity value falls below the measurable lower limit value of a high-resist meter, the volume resistivity value of the carrier cannot be obtained, and therefore, the high-resist meter is regarded as being virtually broken down.

It is preferable to arrange the weight average diameter of toner particles to be not smaller than 4.5 μm and not greater than 8.0 μm and the ratio Dw/Dn to be equal to or smaller than 1.20 where Dw represents the weight average diameter of toner particles and Dn represents the number average diameter of toner particles. Although small diameter toner particles are preferable for higher resolution of toner images, there is a difficulty present in terms of the fluidity and preservation. If the weight average diameter of toner particles is smaller than 4.5 μm, the fluidity of the developer may decline and keeping the evenness of toner density in the developer may be difficult.

When small diameter toner particles are used, the coating rate of toner particles to carrier particles tends to rise. If the coating rate of the toner to the carrier becomes too great, difficulties may happen that the adhesion to carrier particles and scattering of toner particles become worse. However, those difficulties can be improved by making the particle diameter distribution of toner particles small. In other word, it is effective to make the ratio Dw/Dn close to 1 for improving those difficulties. If Dw/Dn is equal to or smaller than 1.20, the decline of the fluidity is improved and toner density in the developer becomes even.

It is preferable to arrange the particle distribution of toner particles so that the number ratio of toner particles having a diameter not greater than 3 μm is equal to or smaller than 5%. By decreasing the number of small diameter toner particles, the quality of toner particles is improved in terms of the fluidity and preservation and it becomes easier to charge toner particles and replenish toner particles to the developing device.

As additive agents to increase the fluidity of the developer, a combination of hydrophobic silica agents and hydrophobic titanium oxide agents is preferably used. In particular, when hydrophobic silica agents and hydrophobic titanium oxide agents each having an average particle diameter not greater than 50 nm are used, the electrostatic force and van der Waals' force between the additive agents and toner particles are raised. In addition, even when the toner particles are agitated in the developing device, additive agents are hardly released from toner particles, and thereby image defects are hardly produced. Further, the quantity of toner particles remaining on the latent image bearing member after transfer process is reduced.

When titanium oxide agents are used as additive agents, the resultant toner particles can stably produce toner images having a proper image density even when environmental conditions are changed. However, the charge rising property of toner particles tend to deteriorate. Therefore if the quantity of titanium oxide agents is greater than that of silica agent, there is a possibility that the charge rising property deteriorates. If the quantity of hydrophobic silica agents is not smaller than 0.3 and not greater than 1.5% by weight and the quantity of hydrophobic titanium oxide agents is not smaller than 0.2 and not greater than 1.2% by weight, the decline of the charging rising property is sufficiently suppressed, the scattering of toner particles is improved and the quality of toner images is stabilized.

It is also preferable to use hydrophobic silica agents having an average diameter not smaller than 80 nm and not greater than 140 nm in order to reduce the adhesion force between toner particles. With those additive agents, it is possible to transfer toner particles sufficiently during the transfer process and to sufficiently suppress the unevenness of toner images caused during the transfer process. Therefore, good quality toner images can be obtained stably.

The carrier is produced by forming a coating layer on the surface of the core particles. Resins for forming the coating layer that can be used include various known resins such as those used when producing the carrier. According to the present invention, a silicone resin including the repeated unit which is expressed by the following formulas can be preferably used.

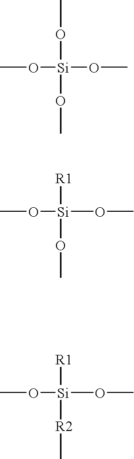

In the formulas, R1 represents a hydrogen atom, a halogen atom, a hydroxyl group, a methoxy group, a lower alkyl group having a carbon number of 1 to 4, or an aryl group such as a phenyl group, a tolyl group, and the like, and R2 represents an alkylene group having a carbon number of 1 to 4 or an arylene group such as a phenylene group, and the like.

In the present invention, straight silicone resins can be used. Examples thereof include, but are not limited to, KR71, KR272, KR282, KR252, KR255, KR152 (manufactured by Shin-Etsu Chemical Co., Ltd.), SR2400, SR2406 (manufactured by Toray Dow Corning Silicone Inc.), and the like. Modified silicone resins can also be used in the present invention. Examples thereof include, but are not limited to, an epoxy modified silicone, an acryl modified silicone, a phenol modified silicone, an urethane modified silicone, a polyester modified silicone, an alkyd modified silicone, and the like.

Specific examples of the modified silicones include, but are not limited to, an epoxy modified product: ES-1001N, an acryl modified silicone: KR-5208, a polyester modified product: KR-5203, an alkyd modified product: KR-206, an urethane modified product: K-305 (all the above manufactured by Shin-Etsu Chemical Co., Ltd.), an epoxy modified product: SR2115, an alkyd modified product: SR2110 (manufactured by Toray Dow Corning Silicone Inc.), and the like. The silicone resins which can be used in the present invention may contain an appropriate amount (0.001% by weight to 30% by weight) of an amino silane coupling agent and such examples thereof include, but are not limited to:

H₂N(CH₂)₃Si(OCH₃)₃
a mass average molecular mass (Mw)=179.3

H₂N(CH₂)₃ Si(OC₂H₅)₃
a mass average molecular mass (Mw)=221.4

H₂NCH₂CH₂CH₂Si(CH₃)₂(OC₂H₅)
a mass average molecular mass (Mw)=161.3

H₂NCH₂CH₂CH₂Si(CH₃)(OC₂H₅)₂
a mass average molecular mass (Mw)=191.3

H₂NCH₂CH₂NHCH₂Si(OCH₃)₃
a mass average molecular mass (Mw)=194.3

H₂NCH₂CH₂NHCH₂CH₂CH₂Si(CH₃)(OCH₃)₂
a mass average molecular mass (Mw)=206.4

H₂NCH₂CH₂NHCH₂CH₂CH₂Si(OCH₃)₃
a mass average molecular mass (Mw)=224.4

(CH₃)₂NCH₂CH₂CH₂Si(CH₃)(OC₂H₅)₂
a mass average molecular mass (Mw)=219.4

(C₄H₉)₂NC₃H₆Si(OCH₃)₃
a mass average molecular mass (Mw)=291.6

Further, the resins coating the surface of carrier core particles include, but are not limited to, styrene resins such as polystyrene, chloropolystyrene, poly-alpha-methylstyrene, styrene-chlorostyrene copolymer, styrene propylene copolymer, styrene butadiene copolymer, styrene vinyl chloride copolymer, styrene vinyl acetate copolymer, styrene maleic acid copolymer, styrene-acrylic acid ester copolymer such as, styrene-methyl acrylate copolymer, styrene-ethyl acrylate copolymer, styrene-butyl acrylate copolymer, styrene-octyl acrylate copolymer, styrene-phenyl acrylate copolymer, and the like, styrene-methacrylate copolymer such as styrene-methyl methacrylate copolymer, styrene-ethyl methacrylate copolymer, styrene-butyl methacrylate copolymer, styrene-phenyl methacrylate copolymer, and the like, styrene-alpha-chloromethyl acrylate copolymer, styrene-acrylonitrile-acrylic ester copolymer, and the like, epoxy resin, polyester resin, polyethylene resin, polypropylene resin, ionomer resin, polyurethane resin, ketone resin, ethylene-ethyl acrylate copolymer, xylene resin, polyamide resin, phenol resin, polycarbonate resin, melamine resin, and the like. These resins can be used alone or in combination with the silicone resin.

Conventional processes useful for forming a coating layer on the surface of carrier core particles include, but are not limited to, a spray dry process, a dipping process, or a powder coating, and the like. Particularly, a process using a coating device of a fluidized bed type is effective in forming a uniform coating layer.

The thickness of the coating layer on the surface of carrier core particles is preferably from 0.02 μm to 1 μm, more preferably from 0.03 μm to 0.8 μm. Since the thickness of the coating layer is extremely small, the particle distribution between the carrier consisting of core particles in which the coating layer is coated and carrier core particles is substantially the same.

The resistivity of carrier particles is adjusted by the resistivity of the coating layer on core particles and also by controlling the thickness thereof.

Further, to adjust the resistivity of carrier particles, conductive fine powders can be added on the coating layer. The conductive fine powders include, but are not limited to, metals or metallic oxide particle such as conductive ZnO, Al, etc., SnO₂ prepared by various processes or SnO₂ on which various elements were doped, boride such as TiB₂, ZnB₂, MoB₂, conductive polymer such as silicon carbide, polyacetylene, polyparaphenylene, poly (para-phenylenesulfod) polypyrrole, polyethylene, carbon black such as farness black, acetylene black, channel black, and the like.

These conductive fine powders are dispersed using the following processes, i.e., the conductive fine powders are poured into a solvent used for the coating or a coating resin solution and uniformly dispersed by means of a dispersing media such as a ball mill, a bead mill or a stirrer having blades for high-speed rotation.

The toner particles used in the developing device of the present invention include at least a binder resin, a colorant, a releasing agent and a charge controlling agent. As the binder resin of toner particles of the present invention, any known resins which have been used as a binder resin of conventional toner particles can be used.

Specific examples of the binder resins for use in toner particles include, but are not limited to, polymers of styrene and its derivatives, such as polystyrene, polychlorostyrene, and polyvinyl toluene; styrene copolymers such as styrene-p-chlorostyrene copolymers, styrene-propylene copolymers, styrene-vinyl toluene copolymers, styrene-vinyl naphthalene copolymers, styrene-methyl acrylate copolymers, styrene-ethyl acrylate copolymers, styrene-butyl acrylate copolymers, styrene-octyl acrylate copolymers, styrene-methyl methacrylate copolymers, styrene-ethyl methacrylate copolymers, styrene-butyl methacrylate copolymers, styrene-methyl alpha-chloromethacrylate copolymers, styrene-acrylonitrile copolymers, styrene-vinyl ethyl ether copolymers, styrene-vinyl methyl ketone copolymers, styrene-butadiene copolymers, styrene-isoprene copolymers, styrene-acrylonitrile-indene copolymers, styrene-maleic acid copolymers, and styrene-maleic acid ester copolymers; and other resins such as polymethyl methacrylate, polybutyl methacrylate, polyvinyl chloride, polyvinyl acetate, polyethylene, polypropylene, polyesters, polyvinyl butyral resins, polyacrylic acid resins, rosin, modified rosin, terpene resins, phenolic resins, aliphatic or alicyclic hydrocarbon resins, aromatic petroleum resins, chlorinated paraffins, and paraffin waxes. These materials can be used alone or in combination.

Specific examples of the colorants for use in the present invention include any known dyes and pigments such as carbon black, Nigrosine dyes, black iron oxide, Naphthol Yellow S, HANSA Yellow (10C, 5G and G), Cadmium Yellow, yellow iron oxide, loess, chrome yellow, Titan Yellow, polyazo yellow, Oil Yellow, HANSA Yellow (GR, A, RN and R), Pigment Yellow L, Benzidine Yellow (G and GR), Permanent Yellow (NCG), Vulcan Fast Yellow (5G and R), Tartrazine Lake, Quinoline Yellow Lake, Anthrazane Yellow BGL, isoindolinone yellow, red iron oxide, red lead, orange lead, cadmium red, cadmium mercury red, antimony orange, Permanent Red 4R, Para Red, Fire Red, p-chloro-o-nitroaniline red, LITHOL Fast Scarlet G, Brilliant Fast Scarlet, Brilliant Carmine BS, Permanent Red (F2R, F4R, FRL, FRLL and F4RH), Fast Scarlet VD, Vulcan Fast Rubine B, Brilliant Scarlet, LITHOL RUBJNE GX, Permanent Red F5R, Brilliant Carmine 6B, Pigment Scarlet 3B, Bordeaux 5B, Toluidine Maroon, Permanent Bordeaux F2K, Helio Bordeaux BL, Bordeaux 10B, BON Maroon Light, BON Maroon Medium, Eosin Lake, Rhodamine Lake B, Rhodamine Lake Y, Alizarine Lake, Thioindigo Red B, Thioindigo Maroon, Oil Red, Quinacridone Red, PYRAZOLONE Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, INDANTHRENE BLUE (RS and BC), Indigo, ultramarine, Prussian blue, Anthraquinone Blue, Aniline Blue, chalco oil blue, Methylene Blue chloride, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, Rose Bengal, lithopone and the like. These materials are used alone or in combination. The content of a coloring agent in toner particles is preferably from about 1 to about 30 parts by weight, and preferably from about 3 to about 20% by weight, of the binder resin.

Suitable charge controlling agents for use in toner particles include known positive or negative charge controlling agents. When color toners are prepared, transparent controlling agents and white charge controlling agents are preferable to impart a good color tone to the resultant color toner particles.

Specific examples of the positive charge controlling agents for use in toner particles include, but are not limited to, quaternary ammonium salts, metal salts and metal complexes of imidazole and the like. Specific examples of the negative charge controlling agents for use in toner particles include, but are not limited to, complexes and salts of salicylic acid, organic boron salts, and calixarene compounds and the like compounds.

In order to impart a releasing ability to toner particles, a wax can be added in the toner. Specific examples of the waxes include, but are not limited to, vegetable waxes such as candelilla wax, carnauba wax, rice wax, Japan wax, and jojoba oil; animal waxes such as beeswax, lanolin, and whale wax; mineral waxes such as montan wax, and ozokerite; fats and oils waxes such as hardened caster oil, hydroxy stearic acid, fatty acid amides, and phenolic fatty acid esters; and the like waxes. These waxes can be used alone or in combination.

Toner particles used in the developing device of the present invention may optionally include additive agents such as plasticizers, resistance controlling agents and the like to improve the thermal characteristics, electric characteristics, and physical characteristics. Specific examples of the plasticizers include, but are not limited to, known plasticizers such as dibutyl phthalate, and dioctyl phthalate. Specific examples of the resistance controlling agents include, but are not limited to, tin oxides, lead oxides, antimony oxides etc.

Toner particles used in the developing device of the present invention may also optionally include a fluidity imparting agent other than the above-mentioned fluidity imparting agents. Specific examples of such fluidity imparting agents include, but are not limited to, fine powders of silica, titanium oxide, aluminum oxide, magnesium fluoride, silicon carbide, boron carbide, titanium carbide, zirconium carbide, boron nitride, titanium nitride, zirconium nitride, magnetite, molybdenum disulfide, aluminum stearate, magnesium stearate, zinc stearate, fluorine-containing resins, acrylic resins etc. These materials can be used alone or in combination. The fluidity imparting agent preferably has a primary particle diameter not greater than 0.1 μm. In addition, the fluidity imparting agent is preferably hydrophobized with a silane coupling agent, a silicone oil or the like such that the agent has a hydrophobic degree not less than 40.

Toner particles used in the developing device of the present invention can be manufactured by any one of known methods. For example, toner particles can be prepared by the following method:

(1) a binder resin, a colorant, and a charge controlling agent are mixed in a proper ratio optionally with a releasing agent using a mixer such as a HENSCHEL mixer, a ball mill or the like;

(2) the mixture is kneaded, while being heated, with a kneader such as an extrusion type continuous kneader having a screw, a two-roll mill, a three roll mill, a kneader applying pressure and the like kneaders;

(3) the kneaded mixture is cooled and then crushed with a crusher such as a hammer mill;

Thus a mother toner can be prepared. When color toners are prepared, a master batch of a pigment or a dye, which is prepared by kneading a pigment or a dye and a part of the binder resin used for the toner, can be typically used as a colorant to improve the dispersibility of the colorant in toner particles.

(4) the crushed mixture is first pulverized with a collision type pulverizer such as a jet mill; and

(5) the first pulverized mixture is subjected to a second pulverization treatment (i.e., a circularizing treatment) with a rotor pulverizer while classified by an air classifier which is connected with the rotor pulverizer.

Specific examples of the collision type pulverizer include jet mills, hammer mills, ball mills, tube mills, vibration mills and the like. Among these pulverizers, jet pulverizers having a jet of blowing air and a collision plate are preferably used. Specific examples of such jet pulverizers include an I type or IDS type collision pulverizer manufactured by Nippon Pneumatic Mfg. Co., Ltd.

As the rotor pulverizer, roll mills, pin mills, fluidized bed type jet mills and the like are exemplified. Among these pulverizers, rotor pulverizers having a container which serves as an outer wall and a rotor which is concentric with the container are preferably used. Specific examples of such rotor pulverizers include Turbo Mills (manufactured by Turbo Industry Co., Ltd.), Kryptron (manufactured by Kawasaki Heavy Industries, Ltd.), and Fine Mills (manufactured by Nippon Pneumatic Mfg. Co., Ltd.).

Specific examples of the connected air classifier include an dispersion separator (DS) type classifier manufactured by Nippon Pneumatic Mfg. Co., Ltd. and multi-division type classifier (Elbow-jet) manufactured by Nittetsu Mining Co., Ltd.

In addition, it is possible to obtain fine toner particles by classifying the pulverized toner using an air classifier and a mechanical classifier. The thus prepared mother toner is then mixed with a fluidity imparting agent using a HENSCHEL mixer, super mixer, ball mill or the like, to prepare toner particles.

Also, toner particles used in the developing device of the present invention can be manufactured by a method such as suspension polymerization method or dispersion polymerization in non-aqueous medium method in which toner particles are manufactured directly from monomers, colorants and fluidity imparting agents.

The developer includes the above-mentioned carrier particles and the above-mentioned toner particles.

The average shape of toner particles can be spherical or non-spherical. Either of magnetic toner particles and non-magnetic toner particles can be used.

A ratio of toner particles to carrier particles is preferably 2 parts by weight to 25 parts by weight of toner particles and is more preferably 4 parts by weight to 15 parts by weight, based on 100 parts by weight of the carrier.

In the developer including carrier particles and toner particles, a coating rate of the toner to the carrier is preferably 10% to 80% and is more preferably 20% to 60%. When the coating rate of toner particles to carrier particles is 50%, the absolute value of charging amount of toner particles is preferably 35 μC/g or smaller and is more preferably 25 μC/g or smaller. The lower limit is not limited but preferably it is approximately 15 μC/g. The charging polarity of toner particles in this embodiment is minus.

In the present application, the weight average particle diameter Dw with respect to carrier particles, carrier core particles and toner particles is calculated based on the particle distribution of particles measured based on a number. The weight average particle diameter Dw is expressed by the following calculation.
Dw={1/Σ(nD3)}×{Σ(nD4)}

In the above calculation, D indicates a representative particle diameter (μm) of a particle existing in each channel, and “n” indicates a total number of particles existing in each channel. The “channel” refers to a length for dividing the range of the particle diameter equally in the particle diameter distribution map. In the present invention, 2 μm is employed. The lower limit value of the particle diameter of the particles stored in the channel is employed as the representative particle diameter of a particle existing in each channel.

The amount of toner particles consumed in one second for the development process “a” (mg/sec) of the present invention can be obtained as follows:

(1) prepare a first measuring instrument to measure a rotation time of the developer bearing member by monitoring an output signal from a motor used to rotate the developer bearing member

(2) set a toner cartridge to a second measuring instrument to measure the weight. Here, the weight of the toner cartridge is measured in advance. If the second measuring instrument has toner container in itself, it is necessary to measure the weight of the toner cartridge after fulfilling toner container in the second measuring instrument with toner particles.

(3) keep forming toner images by the developing device, till the rotation time measured by the first measuring instrument reaches to 20 hours.

(4) measure the weight of toner cartridge after 20 hours of rotation by the second measuring instrument.

(5) subtract the weight of the toner cartridge measured in advance from the weight of the toner cartridge after 20 hours of rotation in order to obtain the amount of the toner consumed

The criterion for judgment to decide whether the amount of the developer on the developer bearing member is increased or not is explained below.

(1) drive the developing device for 30 seconds.

(2) measure the amount of the developer on three points of the developer bearing member. The amount of the developer is defined as the mass of the developer in a unit of the area (mg/cm2). Those three points are a point closer to one end, a point at the center and a point closer to another end of the developer bearing member. At each point, the amount of the developer is measured three times and the average value is regarded as the amount of the developer at each point.

(3) judge that the amount of the developer is increased if the amount of the developer obtained after 20 hours of rotation is greater than the value before rotation at each point of three points. In the calculation, figures after the decimal fractions should be omitted.

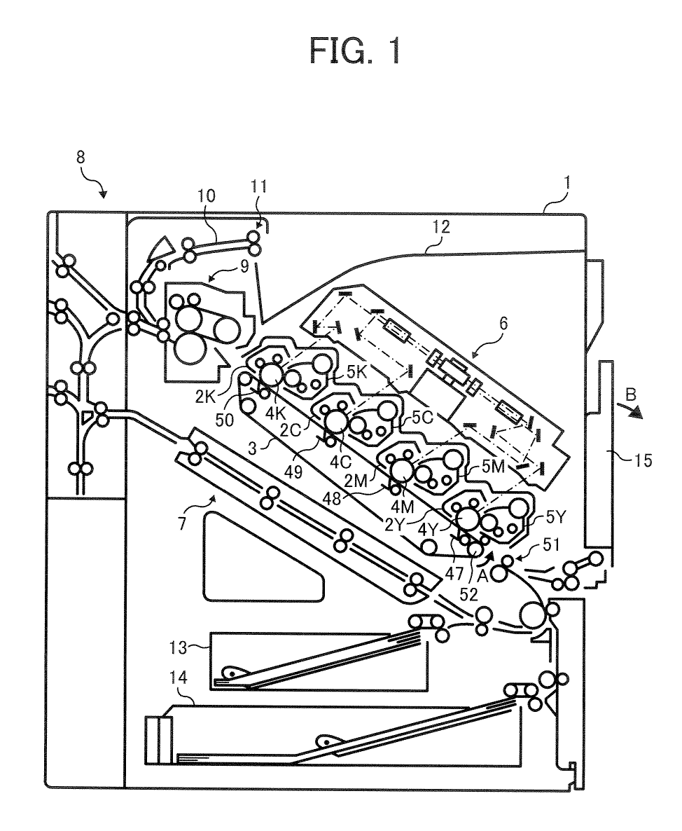

An embodiment of the image forming apparatus will now be described. FIG. 1 illustrates a full-color printer of an electrophotographic type as an image formation apparatus according to the present invention. In FIG. 1, a plurality of photosensitive units 2Y, 2M, 2C, and 2 K as the latent image bearing members are detachably loaded into a box-like apparatus body 1. A transfer belt 3 as a recording medium carrier is disposed approximately at the center of the apparatus body 1 and obliquely in a diagonal direction of the apparatus body 1. The transfer belt 3 is entrained on a plurality of rollers, to one of which the driving force is transmitted, so that the belt 3 can be rotated in a direction indicated with arrow A.

The photosensitive units 2Y, 2M, 2C, and 2K have drum-like photosensitive elements 4Y, 4M, 4 C, and 4K, respectively, and are arranged above the transfer belt 3 in such a manner that surfaces of the photosensitive elements come into contact with the transfer belt 3. The photosensitive units 2Y, 2M, 2C, and 2K are arranged in the order of the respective photosensitive elements 4Y, 4M, 4 C, and 4K so that the photosensitive units 2Y and 2K are positioned on a paper feed side and a fixing device 9 side, respectively. The belt-like photosensitive elements can also be used as the photosensitive elements 4Y, 4M, 4C, and 4K.

Developing devices 5Y, 5M, 5C, and 5 K are detachably disposed in opposition to the photosensitive elements 4Y, 4M, 4C, and 4K, respectively. In the developing devices 5Y, 5M, 5C, and 5K, two-component developer having a plurality of colors is included in order to be supplied to the photosensitive elements 4Y, 4M, 4C, and 4K, respectively for development process.

For example, the two-component developers including yellow (“Y” hereinafter) toner particles and carrier particles, a two-component developer including magenta (“M” hereinafter) toner particles and carrier particles, a two-component developer including cyan (“C” hereinafter) toner particles and carrier particles and a two-component developer including black (“K” hereinafter) toner particles and carrier particles are supplied respectively to electrostatic latent images on the photosensitive elements 4Y, 4M, 4C; and 4K to develop the electrostatic latent images.

In this embodiment, the photosensitive units and the developing devices are set to be independently detachable. But as another embodiment, one photosensitive unit and one developing unit can be structured as one unit and detachable together as a process unit.

A write device 6 as an exposure device is disposed above the photosensitive units 2Y, 2M, 2C, and 2K, while a double-side unit 7 is disposed below those photosensitive units. Further, below the double-side unit 7 are disposed paper feed cassettes 13 and 14 which can receive therein transfer mediums of different sizes. On the left side of the apparatus body 1 is disposed an inverting unit 8, while on the right-hand side of the apparatus body 1 is disposed a manual paper feed tray 15 so that it can be opened and closed in the direction of arrow B. The fixing device 9 is positioned between the transfer belt 3 and the inverting unit 8. An inverting conveyance passage 10 is branched on a downstream side in a transfer medium conveying direction of the fixing device 9, and each transfer medium, which is sheet-like, is conducted to a paper discharge tray 12 by means of paper feed rollers 11 disposed in the inverting conveyance passage 10, the paper discharge tray 12 being provided in an upper portion of the apparatus.

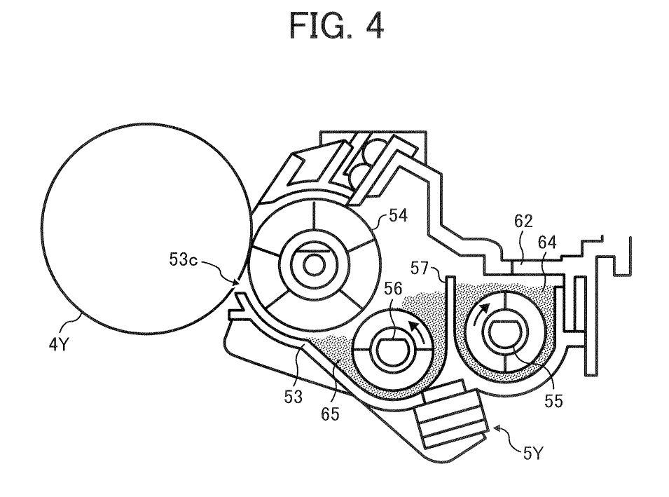

The photosensitive units 2Y, 2M, 2C, and 2K are for forming toner images of Y, M, C, and K colors on the photosensitive elements 4Y, 4M, 4C, and 4K, respectively. They have identical construction except the positions where they are disposed in the apparatus body 1. For example, as shown in FIG. 4, the photosensitive unit 2Y is constituted by an integral unit combination of the photosensitive element 4Y, a charging roller 18Y as a charging device adapted to be in contact with the photosensitive element 4Y, and a cleaning device which cleans the surface of the photosensitive element 4Y with a brush roller 17Y and a cleaning blade 42Y.

The photosensitive unit 2Y thus constructed is detachably attached to the apparatus body 1. As to the constructions of the photosensitive unit 2M, 2C, and 2K, explanations thereof will be omitted.

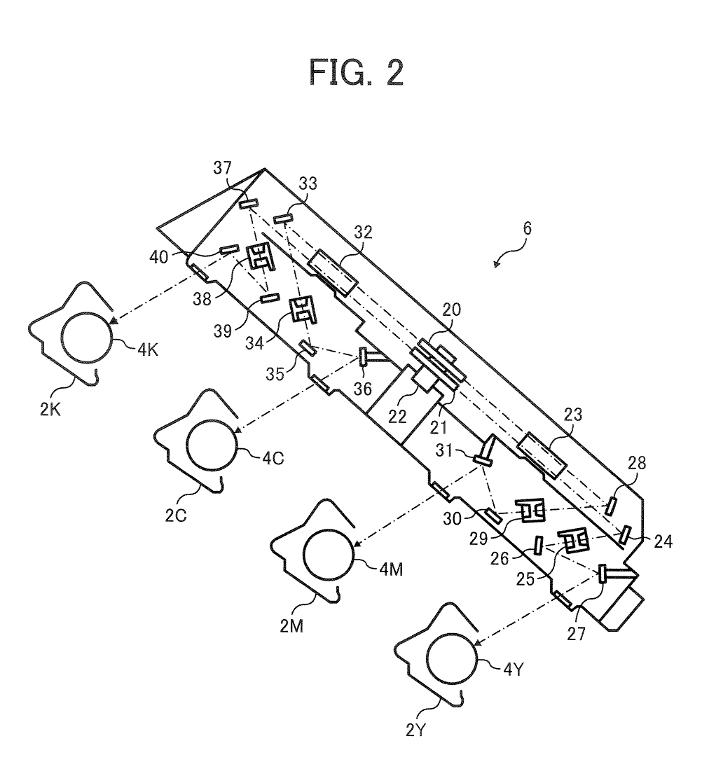

In the write device, as shown in FIG. 2, two rotary polygon mirrors 20 and 21 disposed coaxially are rotated by means of a polygon motor 22. The rotary polygon mirrors 20 and 21 reflect, in a right-left distributed manner, a laser beam for Y modulated with Y image data and a laser beam for M modulated with M image data both emitted from two laser diodes (not shown) as laser beam sources respectively, as well as a laser beam for C modulated with C image data and a laser beam for K modulated with K image data both emitted from two other laser diodes (not shown) as laser beam sources.

The laser beams for Y and M from the rotary polygon mirrors 20 and 21 respectively pass through a two-layer f 0 lens 23. The laser beam for Y having passed through the f-theta lens 23 is reflected by a mirror 24, then passes through an elongated WTL 25, and is thereafter radiated to the photosensitive element 4 Y of the photosensitive unit 2Y through mirrors 26 and 27. The laser beam for M having passed through the fθ lens 23 is reflected by a mirror 28 and passes through an elongated WTL 29, then is radiated to the photosensitive element 4M of the photosensitive unit 2M through mirrors 30 and 31.

The laser beams for C and K reflected from the rotary polygon mirrors 20 and 21 pass through a two-layer fθ lens 32. The laser beam for C having passed through the fθ lens 32 is reflected by a mirror 33 and passes through an elongated WTL 34, then is radiated to the photosensitive element 4C of the photosensitive unit 2C through mirrors 35 and 36. The laser beam for K having passed through the f 0 lens 32 is reflected by a mirror 37 and passes through an elongated WTL 38, then is radiated to the photosensitive element 4K of the photosensitive unit 2K through mirrors 39 and 40.

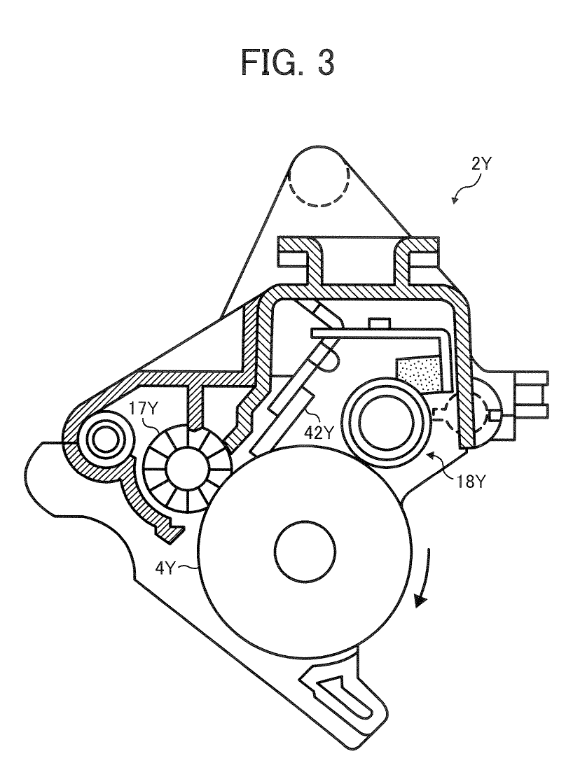

In FIG. 3, an example of the photosensitive unit used in the image forming apparatus is shown. Because the photosensitive units 2Y, 2M, 2C, and 2K have the same structure, only the photosensitive unit 2Y is shown. In FIG. 4, an example of the developing device is shown. For simplicity, color index Y, M, C and K may be omitted and only number index may be used in the following explanation.

The photosensitive elements 4Y, 4M, 4C and 4K are rotated clockwise by motors (not shown) and the photosensitive units 2Y, 2M, 2C, and 2K are uniformly charged by charging rollers 18 (18Y, 18M, 18C and 18K, respectively). Then the laser beam for Y modulated with Y image data, the laser beam for M modulated with M image data, the laser beam for C modulated with C image data and the laser beam for K modulated with K image data are radiated from the write device 6 to the photosensitive elements 4Y, 4M, 4C and 4K respectively and electrostatic latent images are formed on the photosensitive units. Those latent images on the photosensitive elements 4Y, 4M, 4C and 4K are developed by the developing devices 5Y, 5M, 5C and 5K respectively and toner images for each color are formed on the photosensitive elements.

Direct voltage is imposed to transfer toner particles from the developing device to the latent image bearing member in this embodiment. With direct voltage imposed, smaller amount of toner particles transfer to the non-image area on the latent image bearing member than alternative voltage. But image quality tends to be affected by the fluctuation of the amount of the developer. So the present invention is especially effective for the developing device which develops toner images with direct voltage.

One transfer medium is separated from a selected one of the paper feed cassettes 13 and 14 and is fed to a resist roller 51 disposed on the paper feed section side with respect to the photosensitive unit 2Y. In this embodiment, the manual paper feed tray is disposed on the right-hand side of the apparatus body 1 enabling to feed a transfer medium to the resist roller 51 also from the manual paper feed tray 15. The resist roller 51 sends out each transfer medium onto the transfer belt 3 at a timing at which the front end of the transfer medium coincides with the toner image on each of the photosensitive elements 4Y, 4M, 4C, and 4K. The transfer medium thus sent out is electrostatically attracted to the transfer belt 3 which is electrically charged by a paper attracting roller 52, and is conveyed to each transfer section.

While the transfer medium is thus conveyed and passes through the transfer sections successively, toner images of Y, M, C, and K colors on the photosensitive elements 4Y, 4M, 4C, and 4K are successively transferred overlappedly onto the transfer medium by transfer brushes 47, 48, 49 and 50 as transfer devices, whereby forming a four-color overlapped, full-color toner image. The full-color toner image thus formed on the transfer medium is then fixed by the fixing device 9 and is thereafter discharged to the paper discharge tray 12 through a paper discharge passage determined in accordance with a designated mode, or goes straight ahead from the fixing device 9, passes through the interior of the inverting unit 8 and is discharged straight.

The above image forming operations are performed when the four-color overlapped full-color mode is selected by an operating section (not shown). If a three-color overlapped full-color mode is selected by the operating section, the formation of a K toner image is omitted and a full-color image is formed on the transfer medium by overlapping toner images of three Y, M, and C colors. Further, if a black-and-white image forming mode is selected by the operating section, there is performed only the formation of a K toner image and a black-and-white image is formed on the transfer medium.

The developing units 5Y, 5M, 5C, and 5K are of an identical construction except that respective toner colors are different. Therefore, explanation will be given on the construction of the developing unit 5Y as an example. FIG. 4 illustrates the developing unit 5Y. In FIG. 4, the developing unit 5Y includes a development case 53 which contains a two-component developer including Y color toner particles and carrier particles, a developing sleeve 54 disposed within the development case 53 so as to be opposed to the photosensitive element 4Y through an opening 53c of the development case 53, and screw members 55 and 56 disposed within the development case 53, the screw members 55 and 56 serving as agitating members for conveying the developer under agitation. There are magnets inside the developing sleeve and the developing sleeve and the magnets forms a developer bearing member.

The interior of the development case 53 is divided by a partition wall 57 into a first space 65 positioned on the developer supply side for the photosensitive element 4Y and a second space 64 which receives a replenishing toner supplied from a supply port 62. The screw members 56 and 55 are disposed in the spaces 65 and 64, respectively, and are supported by bearings (not shown) disposed in the development case 53 so that the screw members can rotate. The developing sleeve 54 is also supported in the development case 53 through a bearing (not shown) so that it can rotate. The developing sleeve 54 rotates with a driving force transmitted thereto from drive means (not shown).

Although a color image forming apparatus is used in this embodiment, the present invention can also be applied to a monochrome image forming apparatus. For example, by omitting the photosensitive units 2Y, 2M and 2C, and the transfer brushes 47, 48 and 49, a monochrome image forming apparatus to which the present invention can be applied is obtained.

### EXAMPLES

The present invention will be explained with more detailed examples. But the present invention is not limited to those examples.

The word “part” means part by weight.

### Example 1

The following materials were mixed with a HENSCHEL mixer to prepare a mixture in which the agglomerated pigment was soaked with water.

| | |
|---|---|
| Pigment: Quinacridone magenta pigment | 50 parts |
| | (C.I. Pigment Red 122) |
| Binder resin: Epoxy resin | 50 parts |
| Water: | 30 parts |

The mixture was kneaded upon application of heat with a two-roll kneading machine for 45 minutes to prepare a master batch pigment (1).

Toner particles were obtained from the master batch pigment (1) and other materials.

The following components were mixed to prepare a toner preparation material.

| | |
|---|---|
| Binder resin: Epoxy resin | 100 parts |
| (Trademark “R-304”, made by Mitsui Chemicals, Inc.) | |
| Coloring agent: The master batch pigment (1) | 13 parts |
| Charge control agent: Zinc salt of salicylic acid | 2 parts |

(Trademark “Bontron E84”, made by Orient Chemical Industries, Ltd.)

The thus prepared toner preparation material was fused and kneaded in a two-roll mill, and the thus kneaded material was finely pulverized in a jet mill crusher having a plain board type crushing board so that the weight average diameter of the particles might be 7.3 μm. Then, the obtained particles were subjected to classification and surface treatment using a turbo-mill to which the commercially available pneumatic conveying classifier (Trademark “Dispersion Separator DS-Type”, made by Nippon Pneumatic Mfg. Co., Ltd.) was connected, so that the weight average diameter of the particles was 7 μm.

Further, fine particles were classified so that there was obtained the classified toner preparation material having a weight average diameter of 7.5 μm and comprising finely-divided particles with a particle size of 3 μm or less in an amount of 8% in terms of the percentage of the number of particles contained therein.

To 20 kg of the thus classified toner preparation material, 100 g of a commercially available hydrophobic finely-divided silica particles with an average particle diameter of 30 nm and 50 g of a commercially available hydrophobic finely-divided titanium oxide particles with an average particle diameter of 30 nm were added, and the resultant mixture was stirred and mixed to obtain magenta toner particles.

- Production of Carrier -

The following composition was dispersed in a homomixer for 10 minutes to prepare a solution for forming a silicone-containing coating layer.

<Composition>

| | | |
|---|---|---|
| Silicone resin solution: | 132.2 | parts |
| [solid content of 23% | | |
| (SR2410 manufactured by TORAY DOW | | |
| CORNING CO., LTD.)] | | |
| Aminosilane: | 0.66 | parts |
| [solid content of 100% | | |
| (SH6020 manufactured by TORAY DOW | | |
| CORNING CO., LTD.)] | | |
| Inorganic fine particles A: | 145 | parts |
| [aluminum oxides, a particle diameter: 0.40 μm, | | |
| an absolute specific gravity: 3.9, | | |
| a powder specific resistance: 12 [Log (Ω cm)]] | | |
| Toluene: | 300 | parts |

Next, the solution for forming the coating layer was coated on the surface of the core material of calcined ferrite powders (5000 parts) using Spiracoater (manufactured by Okada Seiko K.K.) with an inside temperature of the coater of 40° C. so as to have a coat layer whose thickness was 0.15 μm, and dried. Here, the calcined ferrite powders have an average particle diameter of 35 μm and an absolute specific gravity of 5.5.

The obtained particles were left in an electric furnace at 240° C. for 1 hour and calcined. After cooling down the calcined particles, the ferrite bulk powder was sieved through a sieve of 63 μm mesh and ground to thereby obtain carrier particles 1. The obtained carrier particles 1 had a volume resistivity value of 13.2 [Log (Ωcm)], and a magnetization of 68 Am²/kg.

Obtained color toner particles and obtained carrier particles 1 were mixed and the developer having a toner density of 5 weight % was obtained. The obtained developer were examined in an image forming apparatus (modified IPSiO color 8100: manufactured by Ricoh CO., LTD.). The developing devices including the developing sleeves whose diameter were 17 mm were used in the image forming apparatus and the average value of the amount of the developer on the developing sleeve was 45 mg/cm₂.

The investigation was done in two different conditions as follows:

(1) forming 100,000 sheets of toner images with the image area proportion of 0.5%. A number of sheets fed to the transfer belt within one printing job was 1.

(2) forming 100,000 sheets of toner images with the image area proportion of 10%. A number of sheets fed to the transfer belt within one printing job was 10. “98 mg/m” was the value of “a/b” at the condition in which the amount of the developer after 20 hours of rotation of the developer bearing member exceeds the amount of the developer before rotation.

Here, “a” (mg/sec) indicates the amount of toner particles consumed in one second for the development process and “b” (m/sec) indicates the circumferential velocity of the surface of the developer bearing member.

The value of the amount of the developer is obtained as explained above.

### Example 2

The developer was obtained from the same toner particles as obtained in example 1 and carrier particles obtained by a procedure explained below.

The same examination as example 1 was executed with thus obtained developer.

- Production of Carrier -

The following composition was dispersed in a homomixer for 10 minutes to prepare a solution for forming a silicone-containing coating layer.

<Composition>

| | | |
|---|---|---|
| Silicone resin solution: | 132.2 | parts |
| [solid content of 23% | | |
| (SR2410 manufactured by TORAY DOW | | |
| CORNING CO., LTD.)] | | |
| Aminosilane: | 0.66 | parts |
| [solid content of 100% | | |
| (SH6020 manufactured by TORAY DOW | | |
| CORNING CO., LTD.)] | | |
| Inorganic fine particles B: | 97 | parts |
| [aluminum oxides, a particle diameter: 0.37 μm, | | |
| an absolute specific gravity: 3.9, | | |
| a powder specific resistance: 13 [Log (Ω cm)]] | | |
| Toluene: | 300 | parts |

Next, the solution for forming the coating layer was coated on the surface of the core material of calcined ferrite powders (5000 parts) using Spiracoater (manufactured by Okada Seiko K.K.) with an inside temperature of the coater of 40° C. so as to have coat layer whose thickness was 0.15 μm, and dried. Here, the calcined ferrite powders have an average particle diameter of 35 μm and an absolute specific gravity of 5.5.

The obtained particles were left in an electric furnace at 240° C. for 1 hour and calcined. After cooling down the calcined particles, the ferrite bulk powder was sieved through a sieve of 63 μm mesh and ground to thereby obtain carrier particles 2. The obtained carrier particles 2 had a volume resistivity value of 14.8 [Log (Ωcm)], and a magnetization of 68 Am²/kg.

Color toner particles obtained in an example 1 and carrier particles 2 were mixed and the developer having a toner density of 5 weight % was obtained. The obtained developer were examined in an image forming apparatus (modified IPSiO color 8100: manufactured by Ricoh CO., LTD.). The developing devices including the developing sleeves whose diameter were 17 mm were used in the image forming apparatus and the average value of the amount of the developer on the developing sleeve was 45 mg/cm².

The same investigation as explained in the example 1 was executed.

As the result, “80 mg/m” was the value of “a/b” at the condition in which the amount of the developer after 20 hours of rotation of the developer bearing member exceeds the amount of the developer before rotation.

### Example 3

The developer was obtained from the same toner particles as obtained in example 1 and carrier particles obtained by a procedure explained below.

The same examination as example 1 was executed with thus obtained developer.

- Production of Carrier -

The following composition was dispersed in a homomixer for 10 minutes to prepare a solution for forming a silicone-containing coating layer.

<Composition>

| | | |
|---|---|---|
| Silicone resin solution: | 132.2 | parts |
| [solid content of 23% | | |
| (SR2410 manufactured by TORAY DOW | | |
| CORNING CO., LTD.)] | | |
| Aminosilane: | 0.66 | parts |
| [solid content of 100% | | |
| (SH6020 manufactured by TORAY DOW | | |
| CORNING CO., LTD.)] | | |
| Inorganic fine particles C: | 50 | parts |
| [aluminum oxides, a particle diameter: 0.37 μm, | | |
| an absolute specific gravity: 3.9, | | |
| a powder specific resistance: 11 [Log (Ω cm)]] | | |
| Toluene: | 300 | parts |

Next, the solution for forming the coating layer was coated on the surface of the core material of calcined ferrite powders (5000 parts) using Spiracoater (manufactured by Okada Seiko K.K.) with an inside temperature of the coater of 40° C. so as to have coat layer whose thickness was 0.15 μm, and dried. Here, the calcined ferrite powders have an average particle diameter of 35 μm and an absolute specific gravity of 5.5.

The obtained particles were left in an electric furnace at 240° C. for 1 hour and calcined. After cooling down the calcined particles, the ferrite bulk powder was sieved through a sieve of 63 μm mesh and ground to thereby obtain carrier particles 3. The obtained carrier particles 3 had a volume resistivity value of 11.8 [Log (Ωcm)], and a magnetization of 68 Am²/kg.

Color toner particles obtained in an example 1 and carrier particles 3 were mixed and the developer having a toner density of 5 weight % was obtained. The obtained developer were examined in an image forming apparatus (modified IPSiO color 8100: manufactured by Ricoh CO, LTD.). The developing devices including the developing sleeves whose diameter were 17 mm were used in the image forming apparatus and the average value of the amount of the developer on the developing sleeve was 45 mg/cm².

The same investigation as explained in the example 1 was executed.

As the result, “46 mg/m” was the value of “a/b” at the condition in which the amount of the developer after 20 hours of rotation of the developer bearing member exceeds the amount of the developer before rotation.

### Example 4

20 kg of the classified toner preparation material obtained in the example 1, having a weight average diameter of 7.5 μm and comprising finely-divided particles with a particle size of 3 μm or less in an amount of 8% in terms of the percentage of the number of particles contained therein, was prepared. 100 g of hydrophobic finely-divided silica particles with an average particle diameter of 30 nm and 50 g of hydrophobic finely-divided titanium oxide particles with an average particle diameter of 120 nm were added to the classified toner preparation material, and the resultant mixture was stirred and mixed to obtain magenta toner particles.

Obtained color toner particles and carrier particles 2 obtained in the example 2 were mixed and the developer having a toner density of 5 weight % was obtained. The obtained developer was examined in an image forming apparatus (modified LPSiO color 8100: manufactured by Ricoh CO, LTD.). The developing devices including the developing sleeves whose diameter were 17 mm were used in the image forming apparatus and the average value of the amount of the developer on the developing sleeve was 45 mg/cm².

The same investigation as explained in the example 1 was executed.

As the result, “46 mg/m” was the value of “a/b” at the condition in which the amount of the developer after 20 hours of rotation of the developer bearing member exceeds the amount of the developer before rotation.

### Example 5

The developer was obtained from the same toner particles as obtained in example 1 and carrier particles obtained by a procedure explained below.

The same examination as example 1 was executed with thus obtained developer.

- Production of Carrier -

Carrier particles 4 were obtained from the materials below by using the same procedure explained in the example 2 except the average particle diameter of the calcined ferrite powders was arranged to be 18 μm.

The obtained carrier particles 4 had a volume resistivity value of 15.7 [Log (Ωcm)], and a magnetization of 66 Am²/kg.

<Composition>

| | | |
|---|---|---|
| Acrylic resin solution (solid content of 50%): | 43.7 | parts |
| Guanamine solution (solid content of 70%): | 13.6 | parts |
| Acidic catalyst (solid content of 40%): | 0.24 | parts |
| Silicone resin solution: | 204.4 | parts |
| [solid content of 20% | | |
| (SR2410 manufactured by TORAY DOW | | |
| CORNING CO., LTD.)] | | |
| Aminosilane: | 0.46 | parts |
| [solid content of 100% | | |
| (SH6020 manufactured by TORAY DOW | | |
| CORNING CO., LTD.)] | | |
| Inorganic fine particles D: | 195 | parts |
| [aluminum oxides, a particle diameter: 0.37 μm, | | |
| an absolute specific gravity: 3.9, | | |
| a powder specific resistance: 13 [Log (Ω cm)]] | | |
| Toluene: | 800 | parts |

The color toner particles obtained in example 1 and carrier particles 4 were mixed so that the developer having a toner density of 5 weight % was obtained. The obtained developer was examined in an image forming apparatus (modified IPSiO color 8100: manufactured by Ricoh CO, LTD.). The developing devices including the developing sleeves whose diameter were 17 mm were used in the image forming apparatus and the average value of the amount of the developer on the developing sleeve was 45 mg/cm².

The same investigation as explained in the example 1 was executed.

As the result, “56 mg/m” was the value of “a/b” at the condition in which the amount of the developer after 20 hours of rotation of the developer bearing member exceeds the amount of the developer before rotation.

### Example 6

The developer was obtained from the same toner particles as obtained in example 1 and carrier particles 5 obtained by a procedure explained below.

The same examination as example 1 was executed with thus obtained developer.

- Production of Carrier -

Carrier particles 5 were obtained from the materials below by using the same procedure explained in the example 2 except the average particle diameter of the calcined ferrite powders was arranged to be 71 μm.

The obtained carrier particles 5 had a volume resistivity value of 14.5 [Log (Ωcm)], and a magnetization of 69 Am²/kg.

<Composition>

| | | |
|---|---|---|
| Acrylic resin solution (solid content of 50%): | 39.7 | parts |
| Guanamine solution (solid content of 70%): | 12.4 | parts |
| Acidic catalyst (solid content of 40%): | 0.22 | parts |
| Silicone resin solution: | 185.8 | parts |
| [solid content of 20% | | |
| (SR2410 manufactured by TORAY DOW | | |
| CORNING CO., LTD.)] | | |
| Aminosilane: | 0.42 | parts |
| [solid content of 100% | | |
| (SH6020 manufactured by TORAY DOW | | |
| CORNING CO., LTD.)] | | |
| Inorganic fine particles B: | 60 | parts |
| [aluminum oxides, a particle diameter: 0.37 μm, | | |
| an absolute specific gravity: 3.9, | | |
| a powder specific resistance: 13 [Log (Ω cm)]] | | |
| Toluene: | 800 | parts |

The color toner particles obtained in example 1 and carrier particles 5 were mixed so that the developer having a toner density of 5 weight % was obtained. The obtained developer was examined in an image forming apparatus (modified ISiO color 8100: manufactured by Ricoh CO, LTD.). The developing devices including the developing sleeves whose diameter were 17 mm were used in the image forming apparatus and the average value of the amount of the developer on the developing sleeve was 45 mg/cm².

The same investigation as explained in the example 1 was executed.

As the result, “90 mg/m” was the value of “a/b” at the condition in which the amount of the developer after 20 hours of rotation of the developer bearing member exceeds the amount of the developer before rotation.

### Example 7

The developer was obtained from the same toner particles and the same carrier particles as obtained in example 1.

The same examination as example 1 was executed with the obtained developer except the amount of the developer on the developing sleeve was arranged to be 30 mg/cm2.

“108 mg/m” was the value of “a/b” at the condition in which the amount of the developer after 20 hours of rotation of the developer bearing member exceeds the amount of the developer before rotation.

### Comparative Example 1

The developer was obtained from the same toner particles as obtained in example 1 and carrier particles 6 obtained by a procedure explained below.

The same examination as example 1 was executed with thus obtained developer.

- Production of Carrier -

Carrier particles 6 were obtained from the same materials as the example 1 except the parts of Inorganic fine particles A was arranged to be 30 parts instead of 145 parts in the example 1.

The obtained carrier particles 6 had a volume resistivity value of 16.3 [Log (Ωcm)], and a magnetization of 64 Am²/kg.

Color toner particles obtained in an example 1 and carrier particles 2 were mixed so that the developer had a toner density of 5 weight %. The obtained developer were examined in an image forming apparatus (modified ISiO color 8100: manufactured by Ricoh CO., LTD.). The developing devices including the developing sleeves whose diameter were 17 mm were used in the image forming apparatus and the average value of the amount of the developer on the developing sleeve was 45 mg/cm².

The same investigation as explained in the example 1 was executed.

As the result, “125 mg/m” was the value of “a/b” at the condition in which the amount of the developer after 20 hours of rotation of the developer bearing member exceeds the amount of the developer before rotation.

### Comparative Example 2

The developer was obtained from the same toner particles as obtained in example 1 and carrier particles 7 obtained by a procedure explained below.

The same examination as example 1 was executed with thus obtained developer.

- Production of Carrier -

Carrier particles 7 were obtained from the same materials as the example 1 except the parts of Inorganic fine particles A was arranged to be 60 parts instead of 145 parts in the example 1.

The obtained carrier particles 7 had a volume resistivity value of 16.2 [Log (Ωcm)], and a magnetization of 66 Am²/kg.

Color toner particles obtained in an example 1 and carrier particles 7 were mixed so that the developer had a toner density of 5 weight %. The obtained developer were examined in an image forming apparatus (modified IPSiO color 8100: manufactured by Ricoh CO., LTD.). The developing devices including the developing sleeves whose diameter were 17 mm were used in the image forming apparatus and the average value of the amount of the developer on the developing sleeve was 45 mg/cm².

The same investigation as explained in the example 1 was executed.

As the result, “112 mg/m” was the value of “a/b” at the condition in which the amount of the developer after 20 hours of rotation of the developer bearing member exceeds the amount of the developer before rotation.

### Comparative Example 3

20 kg of the classified toner preparation material obtained in the example 1, having a weight average diameter of 7.5 μm and comprising finely-divided particles with a particle size of 3 μm or less in an amount of 8% in terms of the percentage of the number of particles contained therein, was prepared. 50 g of hydrophobic finely-divided silica particles with an average particle diameter of 30 nm and 200 g of hydrophobic finely-divided titanium oxide particles with an average particle diameter of 30 nm were added to the classified toner preparation material, and the resultant mixture was stirred and mixed to obtain magenta toner particles.

Obtained color toner particles and carrier particles 2 were mixed and the developer having a toner density of 5 weight % was obtained. The obtained developer was examined in an image forming apparatus (modified EPSiO color 8100: manufactured by Ricoh CO, LTD.). The developing devices including the developing sleeves whose diameter were 17 mm were used in the image forming apparatus and the average value of the amount of the developer on the developing sleeve was 45 mg/cm².

The same investigation as explained in the example 1 was executed.

As the result, “43 mg/m” was the value of “a/b” at the condition in which the amount of the developer after 20 hours of rotation of the developer bearing member exceeds the amount of the developer before rotation.

Features of the developer in each example or comparative example are shown in table 1.

The data obtained from examples and comparative examples are shown in table 2. Those data are obtained in the condition that 100,000 sheets of toner images with the image area proportion of 0.5% were formed and a number of sheets fed to the transfer belt within one printing job was 1.

The data obtained from examples and comparative examples are shown in table 3. Those data are obtained in the condition that 100,000 sheets of toner images with the image area proportion of 10% were formed and a number of sheets fed to the transfer belt within one printing job was 10.

Details of some data shown in the tables are explained below.

Image density was obtained as an averaged value of three image densities each measured at a point close to the left side, a point at the center and a point closer to the right side of formed toner image. Each image density is measured with a densitometer X-Rite (from X-Rite Co.).

The target value of image density is set to be from 1.20 to 1.80 (1.50+/−0.30). The fluctuation of image density was classified according to the difference of the image density between the initial data and data taken after 100,000 sheets of image forming. If the difference is smaller than 0.10, the fluctuation of image density was classified as “very good”. If the difference is not smaller than 0.10 and smaller than 0.20, the fluctuation of image density was classified as “good”. If the difference is not smaller than 0.20 and smaller than 0.30, the fluctuation of image density was classified as “not good”. If the difference is equal to or greater than 0.30, the fluctuation of image density was classified as “bad”.

The amount of electric charge of carrier particles is determined by the following procedure. The toner particles are mixed with the carrier particles at a mixture ratio of 5 weight % of the toner particle to 95 weight % of the carrier particles, the mixed sample is frictionally charged. The charged amount of the frictionally charged sample is measured by means of a typically used blow-off unit (TB-200, manufactured by Toshiba Chemical Corp.).

The reduced amount in electric charge of carrier particles is determined by the following procedure. The toner particles are mixed with the carrier particles at a mixture ratio of 5 weight % of the toner particle to 95 weight % of the carrier particles, the mixed sample is frictionally charged. The charged amount (Q1) of the frictionally charged sample is measured by means of a typically used blow-off unit (TB-200, manufactured by Toshiba Chemical Corp.). The toner particles in the developer that have gone through the running were removed using the blow-off unit to obtain carrier particles, and the charged amount (Q2) of the carrier was measured in the same manner as in the charged amount (Q1). Then, the reduced amount in electric charge of carrier particles is calculated by deducting the charged amount (Q2) from the charged amount (Q1). The target value of the reduced amount in charge is within 10.0 μc/g.

The amount of the scattered toner particles was obtained by measuring the weight of toner particles stored in the bottle part of the developing device every 20,000 sheets of image forming and adding thus obtained weights after 100,000 sheets of image forming. If the resultant amount is not greater than 500 mg, the image forming apparatus was regarded to be acceptable.

The amount of the developer on the developer bearing member was obtained according to a procedure explained below.

(1) drive the developing device for 30 seconds.

(2) measure the amount of the developer on three points of the developer bearing member. Those three points are a point closer to one end, a point at the center and a point closer to another end of the developer bearing member. At each point, the amount of the developer is measured three times and the average of those nine values (three data at three points) are regarded as the amount of the developer. In the calculation, figures after the decimal fractions should be omitted.

If the difference between the initial amount of the developer and the amount after 100,000 sheets of image forming is smaller than 5 mg/cm², the image forming apparatus was regarded to be acceptable.

TABLE 1

| | | Volume | resistivity | |
|---|---|---|---|---|
| | | resistivity | value of | |
| | | value of carrier | Inorganic fine | |
| | Carrier | particles | particles | “a/b” |
| | particles | (logΩcm) | (logΩcm) | (mg/m) |
| Example 1 | Carrier | 15.9 | 12 | 98 |
| | particles 1 | | | |
| Example 2 | Carrier | 14.8 | 13 | 80 |
| | particles 2 | | | |
| Example 3 | Carrier | 11.8 | 11 | 46 |
| | particles 3 | | | |
| Example 4 | Carrier | 14.8 | 13 | 46 |
| | particles 2 | | | |
| Example 5 | Carrier | 15.7 | 13 | 56 |
| | particles 4 | | | |
| Example 6 | Carrier | 14.5 | 13 | 90 |
| | particles 5 | | | |
| Example 7 | Carrier | 15.9 | 12 | 108 |
| | particles 1 | | | |
| Comparative | Carrier | 16.3 | 12 | 125 |
| Example 1 | particles 6 | | | |
| Comparative | Carrier | 16.2 | 12 | 112 |
| Example 2 | particles 7 | | | |
| Comparative | Carrier | 14.8 | 13 | 43 |
| Example 3 | particles 2 | | | |

TABLE 2

| | initial data | | | | data taken after 100,000 sheets of image forming | | | | | |
|---|---|---|---|---|---|---|---|---|---|---|
| | | | the | | | | the | | | weight of |
| | | | amount | | | | amount | | | scattered |
| | Q/M | | of the | | | toner | of the | | fluctuation | toner |
| | (−μC/ | TC | developer | Image | Q/M | density | developer | image | of image | particles |
| | g) | (wt %) | (mg/cm2) | Density | (−μC/g) | (wt %) | (mg/cm2) | density | density | (mg) |
| Example 1 | 38 | 5.10 | 45 | 1.53 | 35 | 4.81 | 42 | 1.55 | very good | 78 |
| Example 2 | 35 | 5.10 | 45 | 1.49 | 33 | 4.63 | 43 | 1.51 | very good | 56 |
| Example 3 | 28 | 5.00 | 45 | 1.48 | 27 | 4.25 | 44 | 1.53 | very good | 48 |
| Example 4 | 31 | 5.01 | 45 | 1.40 | 28 | 4.38 | 45 | 1.56 | very good | 50 |
| Example 5 | 38 | 4.98 | 45 | 1.61 | 32 | 4.49 | 46 | 1.61 | very good | 44 |
| Example 6 | 33 | 5.10 | 45 | 1.51 | 31 | 4.77 | 41 | 1.53 | very good | 70 |
| Example 7 | 39 | 5.10 | 30 | 1.51 | 36 | 5.23 | 29 | 1.54 | very good | 78 |
| Comparative | 40 | 5.09 | 45 | 1.41 | 25 | 6.21 | 31 | 1.19 | bad | 621 |
| Example 1 | | | | | | | | | | |
| Comparative | 38 | 5.08 | 45 | 1.51 | 22 | 6.58 | 33 | 1.29 | not good | 534 |
| Example 2 | | | | | | | | | | |
| Comparative | 23 | 5.10 | 45 | 1.50 | 12 | 4.12 | 51 | 1.75 | not good | 958 |
| Example 3 | | | | | | | | | | |

TABLE 3

| | initial data | | | | data taken after 100,000 sheets of image forming | | | | | |
|---|---|---|---|---|---|---|---|---|---|---|
| | | | the | | | | the | | | weight of |
| | | | amount | | | | amount | | | scattered |
| | Q/M | | of the | | | toner | of the | | fluctuation | toner |
| | (−μC/ | TC | developer | Image | Q/M | density | developer | image | of image | particles |
| | g) | (wt %) | (mg/cm2) | Density | (−μC/g) | (wt %) | (mg/cm2) | density | density | (mg) |
| Example 1 | 38 | 5.10 | 45 | 1.53 | 36 | 4.22 | 44 | 1.55 | very good | 121 |
| Example 2 | 35 | 5.10 | 45 | 1.49 | 32 | 4.49 | 45 | 1.51 | very good | 144 |
| Example 3 | 28 | 5.00 | 45 | 1.48 | 25 | 3.85 | 46 | 1.53 | very good | 88 |
| Example 4 | 31 | 5.01 | 45 | 1.40 | 26 | 3.99 | 47 | 1.56 | very good | 84 |
| Example 5 | 38 | 4.98 | 45 | 1.61 | 35 | 4.12 | 47 | 1.61 | very good | 70 |
| Example 6 | 33 | 5.10 | 45 | 1.51 | 29 | 4.28 | 43 | 1.53 | very good | 115 |
| Example 7 | 39 | 5.10 | 30 | 1.51 | 33 | 4.88 | 31 | 1.54 | very good | 169 |
| Comparative | 40 | 5.09 | 45 | 1.41 | 28 | 7.23 | 35 | 1.21 | not good | 1285 |
| Example 1 | | | | | | | | | | |
| Comparative | 38 | 5.08 | 45 | 1.51 | 25 | 7.81 | 38 | 1.26 | not good | 1331 |
| Example 2 | | | | | | | | | | |
| Comparative | 23 | 5.10 | 45 | 1.50 | 11 | 5.80 | 58 | 1.82 | bad | 2230 |
| Example 3 | | | | | | | | | | |

From table 1, it is clear that the value “a/b” is greater than 45 mg/m and smaller than 110 mg/m in Examples, greater than 110 mg/m in Comparative Example 1 and smaller than 45 mg/m in Comparative Example 3.

And as shown in from table 2 and 3, proper image density of toner images was obtained during image formation in the Examples and not obtained in the Comparative Examples.

This application is claiming foreign priority of Japanese patent application No. 2005-355000, filed with the Japanese Patent Office on Dec. 8, 2005, whose entire disclosure is hereby incorporated by reference.

Having now fully described the invention, it will be apparent to one of ordinary skill in the art that many changes and modifications can be made thereto without departing from the spirit and scope of the invention as set forth herein.

1. A developing device for developing latent images on a latent image bearing member to toner images, with developer including toner particles and magnetic carrier particles, comprising:
a developer bearing member for bearing the developer and carrying the developer to an developing area in which the developer bearing member faces to a latent image bearing member so that toner particles transfer to the latent image bearing member and develop the latent image;
wherein an amount of toner particles consumed in one second of the development process “a” (mg/sec) and a circumferential velocity of the surface of the developer bearing member “b” (m/sec) satisfy the following relationship (1) and relationship (2) at a condition in which an amount of the developer after 20 hours of rotation of the developer bearing member exceeds an amount of the developer before rotation:
45 mg/m<a/b (1)
a/b<110 mg/m (2).

2. The developing device according to claim 1, wherein the amount of the developer on the developer bearing member at the developing area is not smaller than 30 mg and not greater than 60 mg.

3. The developing device according to claim 1, wherein the magnetic carrier particles include core particles and aluminum oxide particles on the core particles.

4. The developing device according to claim 1, wherein the average weight diameter of carrier particles is not smaller than 20 μm and not greater than 45 μm.

5. The developing device according to claim 1, wherein the volume resistivity value of carrier particles is not smaller than 10[Log (Ωcm)] and not greater then 16 [Log (Ωcm)].

6. The developing device according to claim 1, wherein the weight average diameter of toner particles is not smaller than 4.5 μm and not greater than 8.0 μm.

7. The developing device according to claim 1, wherein the ratio Dw/Dn is equal to or smaller than 1.20 where Dw represents weight average diameter of toner particles and Dn represents number average diameter of toner particles.

8. The developing device according to claim 1, wherein the number ratio of toner particles having a diameter not greater than 3 μm is equal to or smaller than 5%.

9. The developing device according to claim 1, wherein the toner particles further comprise one or more hydrophobic silica agents having an average particle diameter not greater than 50 nm and one or more hydrophobic titanium oxide agents having an average particle diameter not greater than 50 nm as additive agents to increase fluidity of the developer.

10. The developing device according to claim 9, wherein the one or more hydrophobic silica agents are present in an amount of total hydrophobic silica agents not smaller than 0.3 weight % and not greater than 1.5 weight %, and the one or more hydrophobic titanium agents are present in an amount of total hydrophobic titanium agents not smaller than 0.2 weight % and not greater than 1.2 weight %.

11. The developing device according to claim 1, wherein the toner particles further comprise one or more hydrophobic silica agents having an average particle diameter not smaller than 80 nm and not greater than 140 nm.

12. The developing device according to claim 1, wherein an electric voltage imposed on the developer bearing member for development consists of a direct voltage.

13. A detachable process unit comprising:
a latent image bearing member;
a developing device according to claim 1.

14. A method of developing latent images to toner images using the developing device according to claim 1.

15. An image forming apparatus comprising:
a latent image bearing member;
a developing device for developing a latent image on the latent image bearing member to a toner image using a developer comprising toner particles and magnetic carrier particles, the developing device comprising a developer bearing member for bearing the developer and carrying the developer to an developing area in which the developer bearing member faces to a latent image bearing member so that toner particles transfer to the latent image bearing member and develop the latent image;
wherein an amount of toner particles consumed in one second for the development process “a” (mg/sec) and a circumferential velocity of the surface of the developer bearing member “b” (m/sec) satisfy the following relationships (1) and (2) at the condition in which the amount of the developer after 20 hours of rotation of the developer bearing member exceeds the amount of the developer before rotation:
45 mg/m<a/b (1)
a/b<110 mg/m (2).

16. The image forming apparatus according to claim 15, wherein the image forming apparatus comprises four developing devices, one each for forming yellow, magenta, cyan and black color toner images.

17. The image forming apparatus according to claim 15, wherein the toner particles further comprise one or more hydrophobic silica agents having an average particle diameter not greater than 50 nm and one or more hydrophobic titanium oxide agents having an average particle diameter not greater than 50 nm as additive agents to increase fluidity of the developer.

18. The image forming apparatus according to claim 17, wherein the one or more hydrophobic silica agents are present in an amount of total hydrophobic silica agents not smaller than 0.3 weight % and not greater than 1.5 weight %, and the one or more hydrophobic titanium agents are present in an amount of total hydrophobic titanium agents not smaller than 0.2 weight % and not greater than 1.2 weight %

19. The image forming apparatus according to claim 15, wherein the toner particles further comprise one or more hydrophobic silica agents having an average particle diameter not smaller than 80 m and not greater than 140 nm.

20. The image forming apparatus according to claim 15, wherein an electric voltage imposed on the developer bearing member for development consists of a direct voltage.
